(19) United States
(12) Patent Application Publication
(10) Pub. No.: US 2015/0361703 A1
(43) Pub. Date: Dec. 17, 2015

(54) WIND RESISTANT DOOR ASSEMBLY

(71) Applicant: Advanced Systems, Inc., Clawson, MI (US)

(72) Inventor: Daniel R. McDonald, South Lyon, MI (US)

(21) Appl. No.: 14/736,389

(22) Filed: Jun. 11, 2015

Related U.S. Application Data
(60) Provisional application No. 62/010,591, filed on Jun. 11, 2014.

(51) Int. Cl. E05D 15/24

(52) U.S. Cl. CPC E05D 15/24

(57) ABSTRACT

An industrial door assembly includes a wind resistant door system having a frame and a door. The door is mounted to the frame for movement between an open position and a closed position. The door includes a front fabric panel, a rear fabric panel, a plurality of horizontally extending structural members, and a plurality of vertically extending members. The plurality of horizontally extending structural members are disposed between the front and rear fabric panels. The front and rear fabric panels are both secured to each of the horizontally extending structural members. The plurality of vertically extending members are disposed between the front and rear fabric panels. The plurality of horizontally extending structural members and the plurality of vertically extending members cooperate to subdivide the door into segments that are more resistant to wind.

### CROSS-REFERENCE TO RELATED APPLICATIONS

This application claims the benefit of U.S. Provisional Patent Application No. 62/010,591 filed 11 Jun. 2014 which application is herein expressly incorporated by reference.

### FIELD

The present invention generally relates to industrial doors. More particularly, the present invention relates to a wind resistant industrial door assembly.

### BACKGROUND

Industrial buildings commonly have large access openings. Various types of industrial doors are known for such openings. These doors may be opened and closed with great frequency.

While known industrial doors have generally proven to be acceptable for their intended uses, there remains a need in the pertinent art for continuous improvement.

### SUMMARY

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

In accordance with one particular application, the present teachings provide an industrial door assembly including a frame and a door. The door is mounted to the frame for movement between an open position and a closed position. The door includes a front fabric panel, a rear fabric panel, a plurality of horizontally extending structural members, and a plurality of vertically extending members. The plurality of horizontally extending structural members are disposed between the front and rear fabric panels. The front and rear fabric panels are both secured to each of the horizontally extending structural members. The plurality of vertically extending members are disposed between the front and rear fabric panels. The plurality of horizontally extending structural members and the plurality of vertically extending members cooperate to subdivide the door into segments that are more resistant to wind.

In accordance with another particular application, the present teachings provide an industrial door assembly including a frame and a door mounted to the frame for movement between an open position and a closed position. The door includes at least a first fabric panel, a plurality of horizontally extending structural members, and a plurality of vertically extending members. The first fabric panel secured to each of the horizontally extending structural members. The plurality of horizontally extending structural members and the plurality of vertically extending members cooperate to subdivide the door into segments that are more resistant to wind.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

The present invention will become more fully understood from the detailed description and the accompanying drawings, wherein:

FIG. 1 is an environmental perspective view of an industrial door arrangement constructed in accordance with the present teachings, the industrial door arrangement including first and second wind resistant door systems mounted relative to a door opening of a building.

FIG. 2 is a perspective view of the first wind resistant door system of FIG. 1, the first wind resistant door system shown in a partially raised condition.

FIG. 3 is another perspective view of the first wind resistant door system of FIG. 1, the first wind resistant door system shown in a partially raised condition and shown partially cut away.

FIG. 4A through 4C illustrate header members of the door frame of the first wind resistant door system of the present teachings.

FIG. 5 further illustrate a side jamb/guide of the door frame of the first wind resistant door system of the present teachings.

FIG. 6 further illustrates the first wind resistant door system in accordance with the present teachings, a left side of the first wind resistant door system shown an open position and a right side of the first wind resistant door system shown in a closed position and further shown with a front fabric panel removed for purposes of illustration.

Corresponding reference numerals indicate corresponding parts throughout the several views of the drawings.

### DESCRIPTION OF VARIOUS ASPECTS

The following description of the teachings of the present invention are merely exemplary in nature and are in no way intended to limit the invention, its application, or uses.

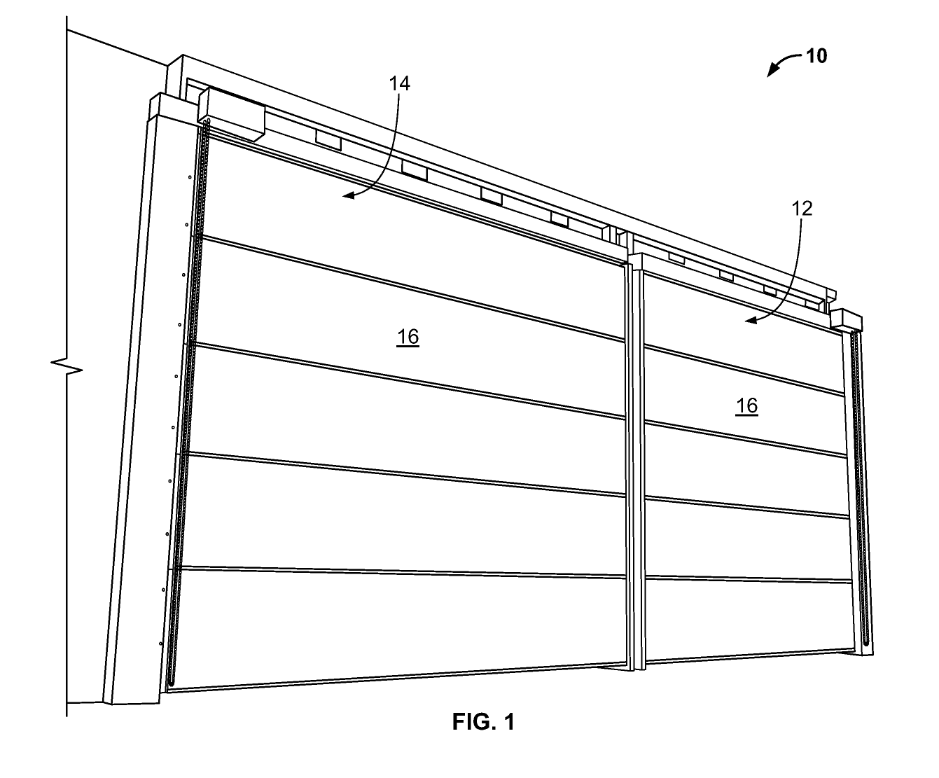

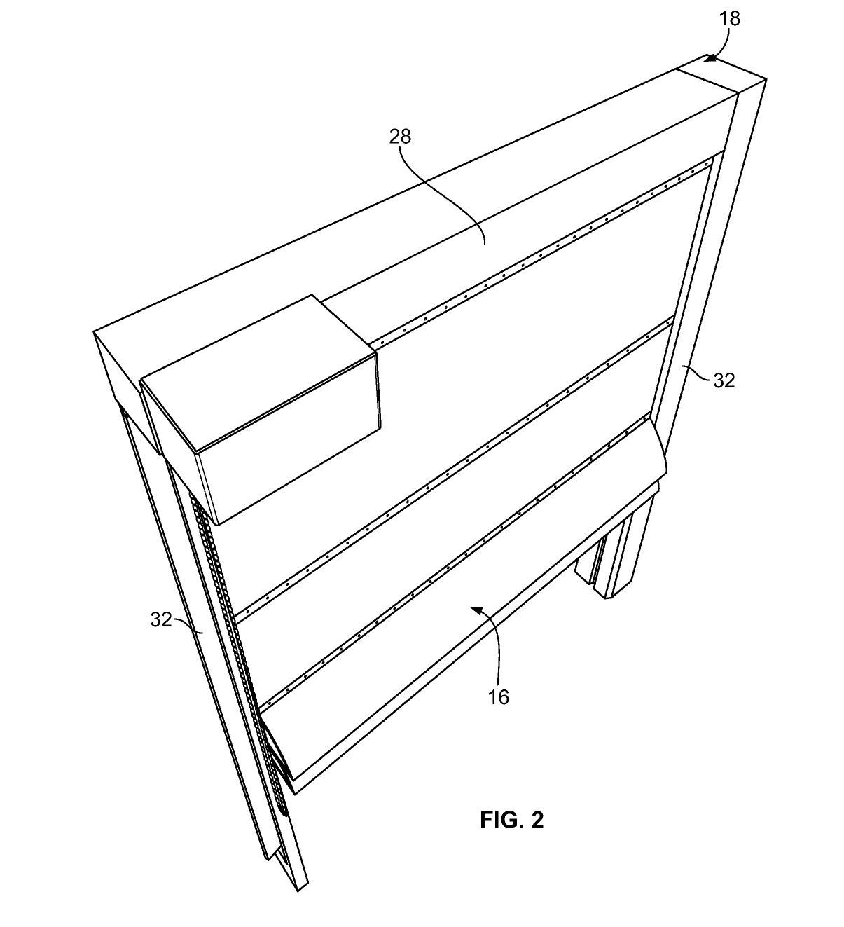

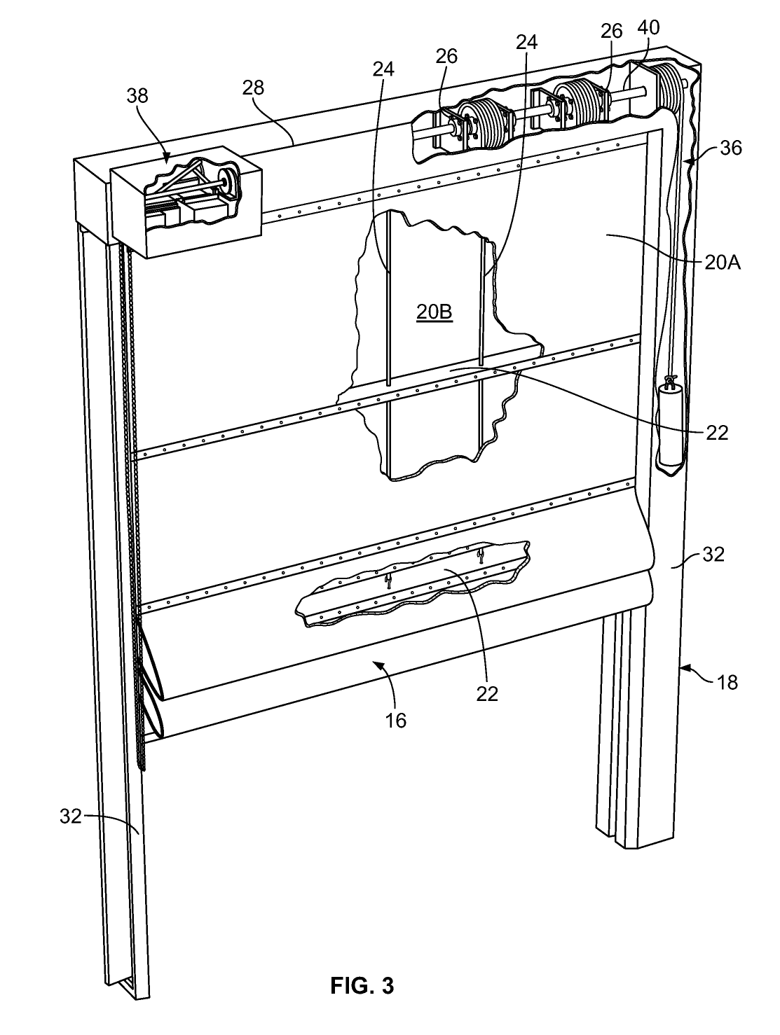

With particular reference to FIG. 1 of the drawings, an industrial door arrangement in accordance with the present teachings is illustrated and generally identified at reference character 10. In the particular embodiment illustrated in FIG. 1, the door arrangement 10 is shown to include first and second wind resistant door systems 12 and 14. As shown, the door systems 12 and 14 are each operatively associated with a door opening of a building and are specifically intended for a commercial application. Each door system 12 and 14 is illustrated to generally include a door 16 that is movable between a closed position (as shown in FIG. 1) and an open position (not shown in FIG. 1, but partially shown in FIGS. 2 and 3, for example).

In the environmental view of FIG. 1, the first door system 12 (i.e., the door system on the right) may have a width of approximately 30 feet and a height of approximately 28 feet. The other door system 14 may have a width of approximately 25 feet and a height of approximately 28 feet. It will be understood that the teachings of the present invention are not limited to any particular dimensions. Rather, these dimensions will be considered to be exemplary and will be understood to be readily adaptable to accommodate various applications within the scope of the present invention.

As will become more apparent below, the present teachings provide a door system 12 and 14 which is resistant to wind. In other words, a door system 12 and 14 constructed in accordance with the present teachings is particularly adapted to withstand operation under higher wind conditions. In this regard, the door systems 12 and 14 of the present teachings may be partitioned into various segments which are less affected by wind.

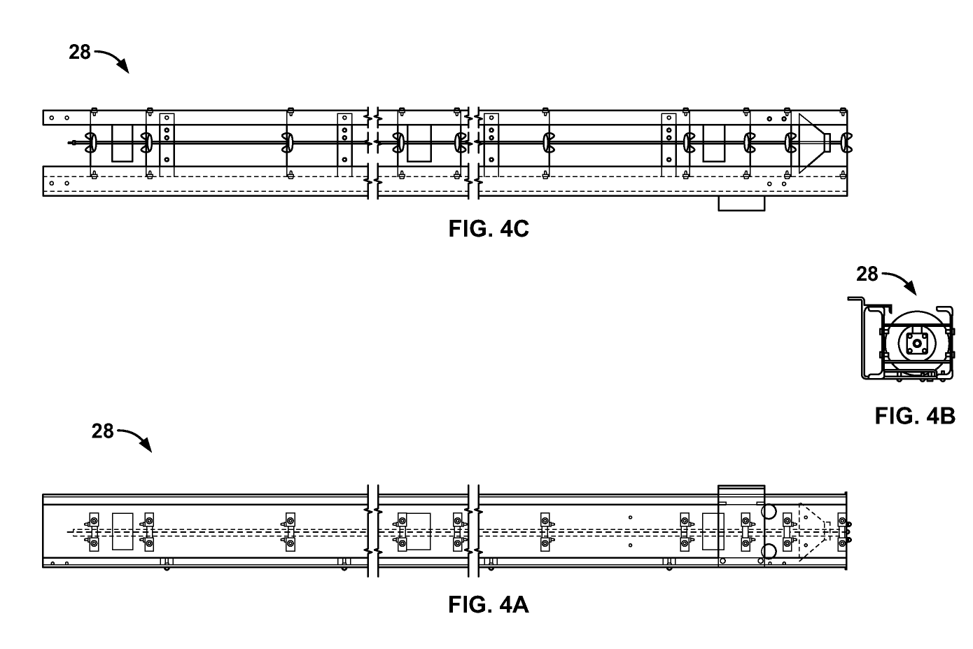

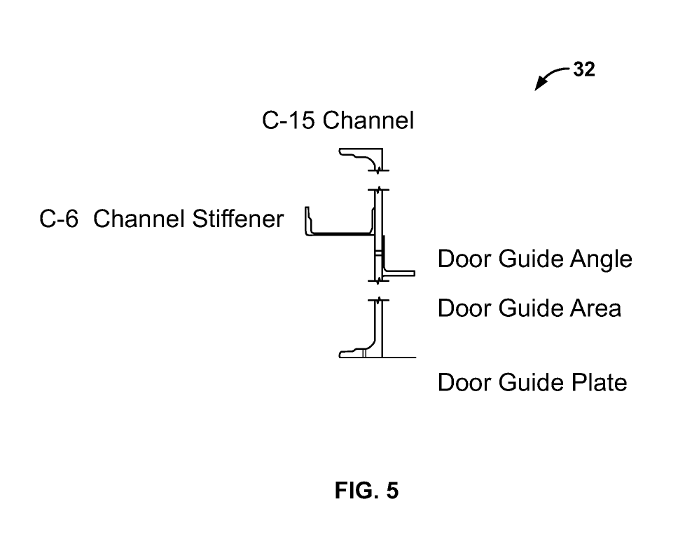

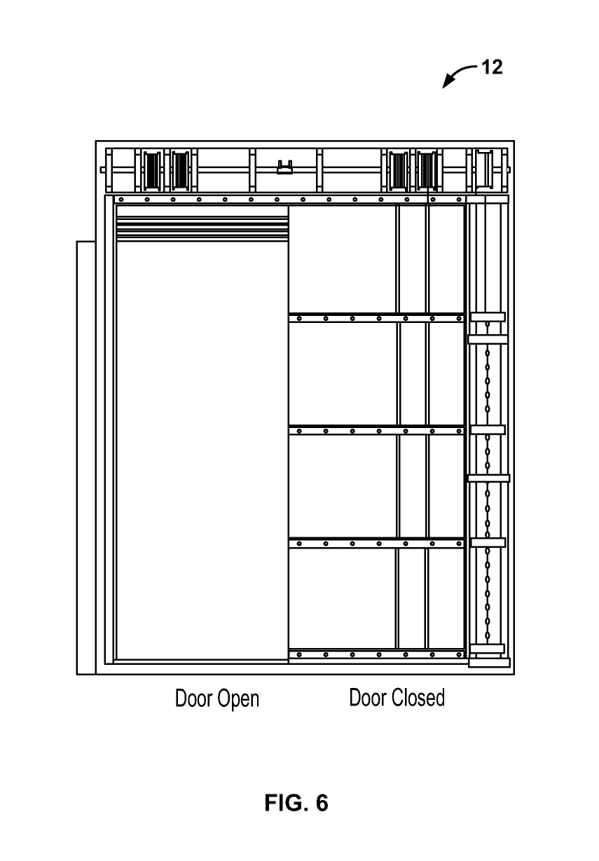

With continued reference to the environmental view of FIG. 1 and additional reference to FIGS. 2 through 6, the various aspects of the present teachings will be further described. It will be understood that the first and second wind resistant door systems are substantially identical except for dimensions. For this reason, the first wind resistant door system 12 need only be described herein. The door 16 of the first wind resistant door system 12 is carried by a frame 18 and movable relative to the frame 18 between the open and closed positions. The door 16 may fold when opening in a manner similar to a venetian blind.

The door 16 may include at least one fabric panel 20. In the embodiment illustrated, the door 16 includes a first or front fabric panel 20A and a second or rear fabric panel 20B. The particular fabric of the front and rear fabric panels 20A and 20B may be selected from any well-known fabric in the art. In one application, however, the fabric of the front and rear fabric panels 20A and 20B is sufficiently flexible to fold as shown in FIGS. 2 and 3, for example.

The door 16 may further include a plurality of structural members. In the embodiment illustrated, the plurality of structural members include a plurality of horizontally extending structural members. The plurality of horizontally extending structural members 22 may be disposed between the front and rear fabric panels 20A and 20B. The front and rear fabric panels 20A and 20B may both be secured to each of the horizontally extending structural members 22. As will be appreciated further below, the plurality of horizontally extending structural members 22 may horizontally divide the door 16 into segments that are more resistant to wind.

The front and rear fabric panels 20A and 20B will be understood to be substantially identical panels. In one application, the front and rear fabric panels 20A and 20B may be constructed of a 28-oz. U.V. stabilized, fire retardant PVC coated polyester. Other materials, however, may be alternatively utilized. Both of the front and rear fabric panels 20A and 20B may be secured to each of the horizontally extending structural members 22 of the plurality of horizontally extending structural members. For example, the front and rear fabric panels 20A and 20B may be secured to the horizontally extending structural members 22 with aluminum clamp strips and water-tight rivets. It will be appreciated, however, that the front and rear fabric panels 20A and 20B may be alternatively secured to each of the horizontally extending structural members 22 in any other manner well-known in the art.

In the embodiment illustrated, the horizontally extending structural members 22 are steel beams. The steel beams may be rectangular steel tubes. The steel beams may be sized and spaced as required to resist wind. In certain applications, the steel beams may be vertically spaced from one another by about 3.0 to 6.0 feet. This spacing defines sails of the door 16.

The door 16 may further include a plurality of vertically extending members 24. The plurality of vertically extending members 24 may similarly be disposed between the front and rear fabric panels 20A and 20B. As will become apparent below, the vertically extending members 24 divide the door 16 in a horizontal direction prevent billowing of the front and rear fabric panels 20A and 20B in between the adjacent horizontally extending structural members 22. Additionally, the vertically extending members 24 cooperate with the horizontally extending structural members 22 to subdivide the door 16 into rectangular door segments having a much less surface area exposed to the wind as compared to the complete surface are of the door 16. In one application, the vertically extending members 24 cooperate with the horizontally extending structural members 22 to subdivide the door 16 into at least 9 rectangular door segments. In other applications, the vertically extending members 24 cooperate with the horizontally extending structural members 22 to subdivide the door 16 into a greater or lesser number of rectangular door segments.

In the embodiment illustrated, the vertically extending members 24 may be steel cables. The steel cables 24 may be anti-rotation cables. In certain applications, the steel cables 24 may be arranged in pairs. Each cable 24 may slidably pass through openings provided in each of the steel beams 22. The pairs of cables 24 may be spaced apart from one another by approximately 8.0 feet. One end of each cable 24 may be attached to a bottom-most steel beam 22. The other end of each cable 24 may be attached to one of a plurality of rotating drums 28 carried by a header member 30 of the frame 18. The outside two cables 24 may define anti-drop cables. The remaining cables 24 may define lifting cables. The outside two cables may prevent the door 16 from dropping in the event a lifting cable fails.

In addition to the header member 30, the frame 18 may include a pair of vertically extending door jambs/guides 32. The frame 18 may be self-supporting and may be easily installed on an interior or an exterior of a building. The system 12 of the present teachings provides for easy face of wall installation on an interior or exterior of a building. The self-supporting structure may connect to a building's existing door jamb and to the building's existing horizontal bracing.

The header member 30 may utilize twin C-15 structural steel channels. This truss type design may minimizes any load on the building or additional support steel of the header member 30. The header member 30 may be shipped fully assembled with operator, cables and covers installed. The self-support side jambs/guides 32 may be shop fabricated where all steel is straightened, welded, drilled, primed and painted to minimize maintenance. The assembly may be shipped fully assembled to reduce installation costs.

The self-supporting jambs/guides 32 may also be C-15 channels. Alternatively, structural steel angle and plate may be used. Both self-support side jambs/guides 32 may be fitted for the steel guides during fabrication and may be shipped fully assembled. The guides may be made from common size steel angle and plate. Alternate material such as UHMW, FRP, vinyl or aluminum may be used.

The door system 12 is designed so that the guides are free from components. Should a collision occur, the door 16 is free to break away from the door guides. In this regard, UHMW material guide blocks may be carried at the ends of steel beams. All cables and hardware will travel with the door 16, thereby minimizing damage and increasing safety.

The door system 12 may include a counterweight system 36. The counterweight system 36 reduces the amount of horsepower required by the operator to raise and lower the door 16. With the counterweight balance system 36, it is much easier for the door 16 to be operated manually using a floor level access brake release and chain hoist. The counterweight system 36 also allows gravity to open or close the door 16 typically to approximately the halfway point. This can be extremely important for emergency egress. The counterweight system 36 may include a carrier, weights, a cable drum, a cable and a tower. In alternative applications, the door system may be constructed and operated without a counterweight system.

A manual brake release may be located on the same side of the door 16 as the operator. The brake release may be operated by one person from the floor. Releasing the brake will allow gravity and the counterweight system 36 to partially open or close the door 16. The brake release includes a chain having a keeper for holding the brake disengaged during manual hoist operation. The brake release may be monitored by a safety power cutoff switch to prevent electrical operation while in manual operation mode.

The door system 12 may also include a floor level manual chain hoist. The manual chain hoist may be operated by one person from floor level. Pulling a chain or cable located next to the manual chain hoist engages the manual hoist with the motorized operator. A safety switch may be provided to disconnect power and prevent accidental electrical operation. With the manual chain hoist engaged, pulling on an endless hand chain raises or lowers the door. Much of the hoist chain pulling may be minimized by gravity opening or closing the door via the counterweight system 36.

The door system 12 may also be provided with a permanent manual chain hoist operator. This is typically used on doors that do not require frequent open and closing. A door with a manual chain hoist may still be weight counterbalanced so that gravity will partially open or close the door.

Accordingly, it will be appreciated that the present teachings provide a door assembly that may be operated in adverse wind conditions not acceptable for other door assemblies due to the sectional nature of the fabric panels.

In operation, the bottom steel beam 22 is raised by a motor/gearbox/brake assembly 38 that turns a shaft 40 with cable drums 26 that wind the stainless steel lifting and safety cables 22 onto individual cable drums 26. As the bottom beam 22 travels to the open position, the remaining horizontal beams 22 stack up on the bottom beam 22 with the fabric panels 20A and 20B folding into pleats. Open and closed positions may be controlled via adjustment limit switches on the operator. Reversing sensors may monitor the door when closing.

Although the exemplary embodiments of the present invention have been described, it is understood that the exemplary embodiments help one of ordinary skill in the art to easily realize a wind resistant industrial door system 10 of the present invention, but the present invention should not be limited to these exemplary embodiments and accompanying drawings. Therefore, various changes and modifications can be apparently made by one skilled in the art without departing from the technical spirit of the present invention. In addition, it is understood that parts that can be easily changed by one skilled in the art are within the spirit and scope of the present invention as hereinafter claimed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. One or more example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

What is claimed is:

1. An industrial door assembly comprising:
a frame; and
a door mounted to the frame for movement between an open position and a closed position, the door including a front fabric panel, a rear fabric panel, a plurality of horizontally extending structural members, and a plurality of vertically extending members, the plurality of horizontally extending structural members disposed between the front and rear fabric panels, the front and rear fabric panels both secured to each of the horizontally extending structural members, the plurality of vertically extending members disposed between the front and rear fabric panels;
wherein the plurality of horizontally extending structural members and the plurality of vertically extending members cooperate to subdivide the door into segments that are more resistant to wind.

2. The industrial door assembly of claim 1, wherein the plurality of horizontally extending structural members are steel beams.

3. The industrial door assembly of claim 2, wherein the plurality of vertically extending members are steel cables.

4. The industrial door assembly of claim 3, wherein the steel cables pass through openings in each of the horizontally extending structural members.

5. The industrial door assembly of claim 3, wherein each steel cable includes a first end attached to a bottom-most one of the horizontally extending structural members and a second end attached to one of a plurality of rotating drums carried by a header member of the frame.

6. The industrial door assembly of claim 5, wherein outermost cables of the plurality of steel cables define two anti-drop cables and the remaining cables define lifting cables.

7. The industrial door assembly of claim 1, wherein the frame is a self-supporting frame.

8. The industrial door assembly of claim 7, wherein the self-supporting frame may be installed on an interior or an exterior of a building.

9. An industrial door assembly comprising:
a frame; and
a door mounted to the frame for movement between an open position and a closed position, the door including at least a first fabric panel, a plurality of horizontally extending structural members, and a plurality of vertically extending members, the first fabric panel secured to each of the horizontally extending structural members;
wherein the plurality of horizontally extending structural members and the plurality of vertically extending members cooperate to subdivide the door into segments that are more resistant to wind.

10. The industrial door assembly of claim 9, wherein the plurality of horizontally extending structural members are steel beams.

11. The industrial door assembly of claim 10, wherein the plurality of vertically extending members are steel cables.

12. The industrial door assembly of claim 9, further comprising a second fabric panel, the plurality of horizontally extending structural members and the plurality of vertically extending members disposed between the first and second fabric panels.

13. The industrial door assembly of claim 12, wherein the second fabric panel is secured to each of the horizontally extending structural members.

14. The industrial door assembly of claim 11, wherein the steel cables pass through openings in each of the horizontally extending structural members.

15. The industrial door assembly of claim 14, wherein each steel cable includes a first end attached to a bottom-most one of the horizontally extending structural members and a second end attached to one of a plurality of rotating drums carried by a header member of the frame.

16. The industrial door assembly of claim 14, wherein outermost cables of the plurality of steel cables define two anti-drop cables and the remaining cables define lifting cables.

17. The industrial door assembly of claim 9, wherein the frame is a self-supporting frame.

18. The industrial door assembly of claim 17, wherein the self-supporting frame may be installed on an interior or an exterior of a building.
